(19) United States
(12) Patent Application Publication
(10) Pub. No.: US 2006/0232821 A1
(43) Pub. Date: Oct. 19, 2006

(54) Parallel architecture for vector color error diffusion

(76) Inventor: Sridharan Ranganathan, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/107,164

(22) Filed: Apr. 15, 2005

(51) Int. Cl. H04N 1/40

(52) U.S. Cl. 358/3.03

(57) ABSTRACT

Apparatus, systems and methods for implementing a parallel architecture for vector color error diffusion are disclosed. In one implementation, a system includes processing logic and an image output device responsive to the image processor. The processing logic being capable of at least thresholding intermediate values of color components of input image pixel data to generate output color component values and associated component error values, sequentially multiplying, in a substantially parallel manner, the component error values by corresponding error diffusion coefficients to generate component diffused error values, and temporarily storing at least one of the component diffused error values in a circular error buffer.

### BACKGROUND

Digital halftoning is a dithering technique commonly used to convert images to a lower amplitude resolution. For example, grayscale halftoning may convert an image in which each pixel is represented by 8-bit gray levels (i.e., 0 . . . 255) to a bi-tonal image in which each pixel is represented by 1-bit or binary levels (i.e., on/off or one/zero). Error diffusion (ED) is a process in which the quantization error created by digital halftoning is distributed to neighboring pixels of each halftone pixel based on the weights of a selected ED filter.

In color halftoning, where each pixel is typically represented by four color components (e.g., cyan-magenta-yellow-black (CMYK)), each component needs to be converted to a lower amplitude resolution. For example, in printer systems a 32-bit CMYK pixel may be converted to a 4-bit pixel where each color component has been converted from an 8-bit value to a 1-bit value. However, color halftoning techniques using scalar ED, in which each component is treated separately and converted in the manner similar to grayscale halftoning, may yield unsatisfactory results because it assumes that the color components are completely separable.

By contrast, vector color error diffusion operates on all four components simultaneously while taking into consideration the dependencies between the color components. By allowing the values of the components to influence each other, the results obtained from vector error diffusion techniques are generally superior in quality. However, the data paths as well as the computing requirements for color halftoning using vector ED processes are significantly greater than those for scalar ED processes.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 illustrates an example image processing system;

FIG. 2 illustrates the image processor of the system of FIG. 1 in more detail;

FIG. 3 illustrates a portion of the image processor of FIG. 2 in more detail;

FIG. 4 illustrates a portion of an ED core of FIG. 3 in more detail;

FIG. 5 is a flow chart illustrating an example process of diffusing error values;

FIGS. 6A and 6B illustrate example ED filter structures;

FIG. 7 is a flow chart illustrating portions of the process of FIG. 5 in greater detail; and,

FIG. 8 illustrates example circular error buffer operations under the process of FIG. 7 for the two different filter sizes of FIGS. 6A and 6B.

### DETAILED DESCRIPTION

The following detailed description refers to the accompanying drawings. The same reference numbers may be used in different drawings to identify the same or similar elements. In the following description specific details are set forth such as particular structures, architectures, interfaces, techniques, etc. in order to provide a thorough understanding of the various aspects of the claimed invention. However, such details are provided for purposes of explanation and should not be viewed as limiting. Moreover, it will be apparent to those skilled in the art, having the benefit of the present disclosure, that the various aspects of the invention claimed may be practiced in other examples that depart from these specific details. In certain instances, descriptions of well known devices, circuits, and methods are omitted so as not to obscure the description of the present invention with unnecessary detail.

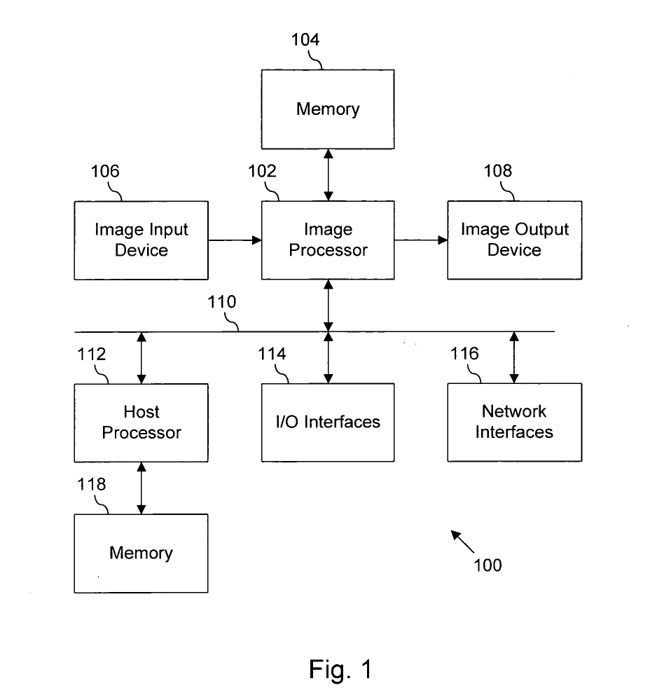

FIG. 1 illustrates an example system 100 according to one implementation of the invention. System 100 may include one or more image processors (IP) 102, memory 104, one or more image data input devices 106, and one or more image data output devices 108. In addition, in one implementation, IP 102 may communicate over a shared bus 110 or other communications pathway with a host processor 112, one or more input/output (I/O) interfaces 114 (e.g., universal synchronous bus (USB) interfaces, parallel ports, serial ports, telephone ports, and/or other I/O interfaces), and/or one or more network interfaces 116 (e.g., wired and/or wireless local area network (LAN) and/or wide area network (WAN) and/or personal area network (PAN), and/or other wired and/or wireless network interfaces). Host processor 112 may also communicate with one or more memory devices 118.

System 100 may assume a variety of physical implementations. For example, system 100 may be implemented in a printer, a personal computer (PC), a networked PC, a server computing system, a handheld computing platform (e.g., a personal digital assistant (PDA)), cell phone, etc. Moreover, while all components of system 100 may be implemented within a single device, such as a system-on-a-chip (SOC) integrated circuit (IC), components of system 100 may also be distributed across multiple ICs or devices. For example, host processor 112 along with components 112-116 may be implemented as one or more ICs contained within a single PC while image processor 102 and components 104-108 may be implemented in a separate device such as a printer coupled to host processor 102 and components 112-116 through communications pathway 110.

Image processor 102 may include one or more devices capable of performing one or more image processing functions. Moreover, image processor 102 may comprise any combination of hardware, firmware and/or software capable of implementing a parallel architecture for vector color error processing in accordance with the claimed invention. Thus, those skilled in the art will recognize that whenever the term “processing logic” is used herein that term may refer to any combination of hardware, firmware and/or software capable of implementing a parallel architecture for vector color error processing in accordance with the claimed invention. For example, image processor 102 may also be referred to as one implementation of processing logic consistent with the claimed invention.

In one implementation, image processor 102 may receive color image data (e.g., in the form of color image pixel data comprising discrete color component values) from memory 104 and/or from image data input device 106. In one implementation, image processor 102 may provide a parallel architecture for digital halftoning of the color image data using vector color error diffusion (ED) in accordance with the invention. Image processor 102 may output the halftone image data to memory 104 and/or image output device 108.

Memory 104 and/or memory 118 may be any device and/or mechanism capable of storing and/or holding color image data, color pixel data and/or component values, to name a few examples. For example, although the invention is not limited in this regard, memory 104 may be volatile memory such as static random access memory (SRAM) or dynamic random access memory (DRAM). For example, although the invention is not limited in this regard, memory 118 may be non-volatile memory such as flash memory.

Image data input device(s) 106 may include any of a number of mechanisms and/or device(s) suitable for capturing and/or providing image data. For example, although the invention is not limited in this regard, an image data input device 106 may include a hard drive or other data storage device capable of storing and/or providing 32-bit cyan-magenta-yellow-black (CMYK) pixel data where each color component value has 8-bit depth.

Image data output device(s) 108 may include any of a number of mechanisms and/or device(s) that consume and/or display halftone processed color image data. For example, although the invention is not limited in this regard, image output device 108 may comprise a color printer capable of printing halftone processed image data comprising 4-bit CMYK pixel data where each color component value has 1-bit depth.

Host processor 112 may be, in various implementations, a special purpose or a general purpose processor. Further, host processor 112 may comprise a single device (e.g., a microprocessor or ASIC) or multiple devices. In one implementation, host processor 112 may be capable of performing any of a number of tasks that support halftone image processing. These tasks may include, for example, although the invention is not limited in this regard, providing ED filtering coefficients to IP 102, downloading microcode to IP 102, initializing and/or configuring registers within IP 102, interrupt servicing, and providing a bus interface for uploading and/or downloading color image data. In alternate implementations, some or all of these functions may be performed by IP 102.

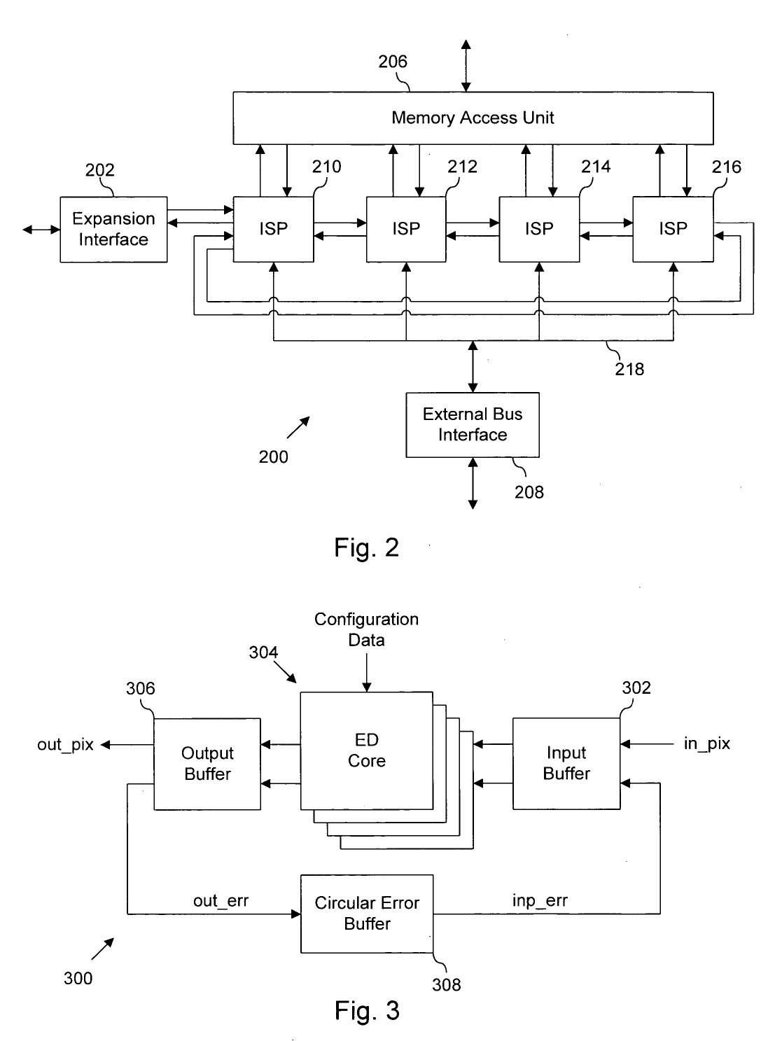

FIG. 2 is a simplified block diagram of an image processing device 200 (e.g., image processor 102, FIG. 1) for use in halftone image processing, in accordance with an implementation of the invention. Image processing device 200 may include one or more expansion interfaces 202, one or more memory access units 206, one or more external bus interfaces 208, and one or more image signal processors (ISPs) 210, 212, 214, 216.

In one implementation, expansion interfaces 202 may enable image processing device 200 to be connected to other devices and/or integrated circuits (ICs) within a system (e.g., image data input device 106 and/or image data output device 108, FIG. 1). Each expansion interface 202 may be programmable to accommodate the device to which it is connected. In one implementation, each expansion interface 202 may include a parallel I/O interface (e.g., an 8-bit, 16-bit or other interface), and the expansion interfaces 202 may use the parallel I/O interface to simultaneously transfer data, such as image pixel data, into and/or out of device 200.

Memory access unit 206 may enable data such as color image data to be stored within and/or retrieved from an external memory device (e.g., memory 104, FIG. 1). However, the invention is not limited in this regard, and, for example, device 200 may include internal memory (not shown) for storing and/or holding data such data. In one implementation, memory access unit 206 may support a parallel (e.g., 8-bit, 16-bit or other) interface.

External bus interface 208 may enable device 200 to connect to an external bus (e.g., bus 110, FIG. 1). In one implementation, bus interface 208 may enable device 200 to receive ED filter coefficients, microcode, configuration information, debug information, and/or other information or data from an external host processor (e.g., processor 112, FIG. 1), and to provide that information to ISPs 210, 212, 214, 216 via a global bus 218.

Image data may be halftone processed by one or more of ISPs 210-216. In one implementation, ISPs 210-216 may be interconnected in a mesh-type configuration, although the invention is not limited in this regard. ISPs 210-216 may process data in parallel and/or in series, and each ISP 210-216 may perform the same or different functions. Further, ISPs 210-216 may have identical or different architectures. Although four ISPs 210-216 are illustrated, in other implementations device 200 may have more or fewer ISPs than ISPs 210-216.

In one implementation, at least one ISP 210-216 is capable of executing a parallel architecture for vector color ED in accordance with the invention. More particularly, at least one ISP 210-216 may implement a parallel architecture for vector color ED where ED coefficients may be selected and/or reconfigured any number of times in accordance with the invention. Methods and apparatus for implementing vector color ED will be described in more detail below.

FIG. 3 is a simplified block diagram of an image processing device 300, e.g., portions of ISP 210 of FIG. 2, for use in a parallel architecture for vector ED processing in accordance with an implementation of the invention. Device 300 includes an input buffer 302, ED cores 304, an output buffer 306, and a circular error buffer 308. Those skilled in the art will recognize that some components typically found in image processing devices and not particularly germane to the claimed invention (e.g., color space conversion components, image scaling components etc.) have been excluded from FIG. 3.

Input buffer 302 may comprise any suitable means for storing and/or holding input pixel component values (inp_pix) and/or input error values (inp_err) associated with those component values. For example, although the invention is not limited in this regard, buffer 302 may comprise memory, such as one or more registers internal to ISP 210 of FIG. 2. In one implementation, buffer 302 stores and/or holds input pixel data in the form of packed 32-bit CMYK pixel data comprising 8-bit color component values, although the invention is not limited in this regard and other pixel data formats may be stored and/or held in buffer 302. Moreover, although the invention is not limited in this regard, the input error values stored and/or held in buffer 302 may be in a packed 32-bit data format comprising four 8-bit input error values associated with respective color component values.

In accordance with the invention, each of ED cores 304 may receive input component values and/or associated input error values from buffer 302 and may be capable of diffusing errors derived from vector ED processing of those input component and associated input error values as will be described in more detail below. In one implementation, ED core 304 may be capable of unpacking 32-bit CMYK input pixel data received from buffer 302 into its constituent component values and/or unpacking the associated input error data received from buffer 302 into its constituent component input error values.

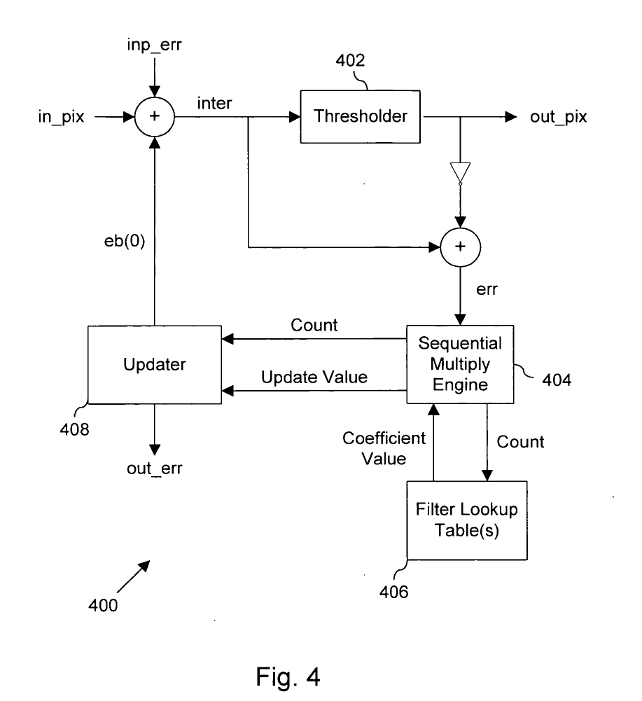

Moreover, in accordance with one implementation of the invention, ED cores 304 may be capable of performing vector ED determinations for unpacked 32-bit CMYK pixel data where ED cores 304 comprise four substantially similar ED cores each capable of performing, in a substantially parallel manner, vector ED determination for a corresponding one of the four 8-bit CMYK color components. Each ED core 304 may thus generate a vector ED derived output error value for the corresponding color component value. In other words, each ED core 304 may generate both vector ED processed halftone color component values and associated diffused error values. Each ED core 304 includes several components that will be described in more detail below with reference to FIG. 4.

In one implementation, ED cores 304 may provide vector ED processed halftone color component output values (out_pix) and associated output error values (out_err) to output buffer 306. Output buffer 306 may be any suitable means for storing and/or holding output halftone component values and/or associated output error values. For example, although the invention is not limited in this regard, buffer 306 may comprise memory, such as one or more registers contained within ISP 210 of FIG. 2. In one implementation, buffer 306 stores and/or holds output component values in the form of packed 4-bit halftone CMYK pixel data, although the invention is not limited in this regard and other pixel data formats may be stored and/or held in buffer 306. In addition, buffer 306 may also store and/or hold output error values received from ED cores 304 as will be described in more detail below. Although the invention is not limited in this regard, the output error values stored and/or held in buffer 306 may also be in a packed data format. In one implementation, buffer 306 stores and/or holds 8-bit output component error values in the form of packed 32-bit error data.

Circular error buffer 308 may comprise any suitable means for storing and/or holding output error values and/or data associated with halftone pixel data generated by ED cores 304 and provided by output buffer 306. For example, although the invention is not limited in this regard, error buffer 308 may comprise memory, such as one or more registers within one or more of ISPs 210-216 of FIG. 2. Alternatively, in another implementation, buffer 308 may comprise memory such as memory 104 that may be accessed by ISPs 210-216 via memory access unit 206. In one implementation, error buffer 308 stores and/or holds output error data in a 32-bit packed format comprising the four 8-bit output error values associated with the color components of the halftone CMYK pixel data generated by ED cores 304, although the invention is not limited in this regard and other error data formats may be stored and/or held in error buffer 308.

In accordance with the invention, error buffer 308 may be continuously updated with output error data and/or values provided by output buffer 306 as those quantities are generated by ED cores 304 in the vector ED processing of input pixel data and/or component values. Moreover, in accordance with the invention, error buffer 308 may continuously provide updated input error data and/or values to input buffer 302 to be used by ED cores 304 in the vector ED processing of input pixel data and/or component values.

In one implementation, for error diffusion processing of pixel data (e.g., pixel component values) in one row of image data, error buffer 308 may hold both error data resulting from error diffusion processing of the previous row of data (i.e., from the row above the row being processed) as well as error data from the row being processed to be used in error diffusion processing of a subsequent row of image data. Moreover, the claimed invention is not limited with respect to which devices perform the error diffusion processing for any particular row or rows of image data. For example, in accordance with the invention, buffer 308 may hold error data generated and/or used by ISP 210 during the processing of one swath of image data comprising one or more rows of image data while buffer 308 may also hold error data generated and/or used by ISP 212 during the parallel processing of another swath of image data.

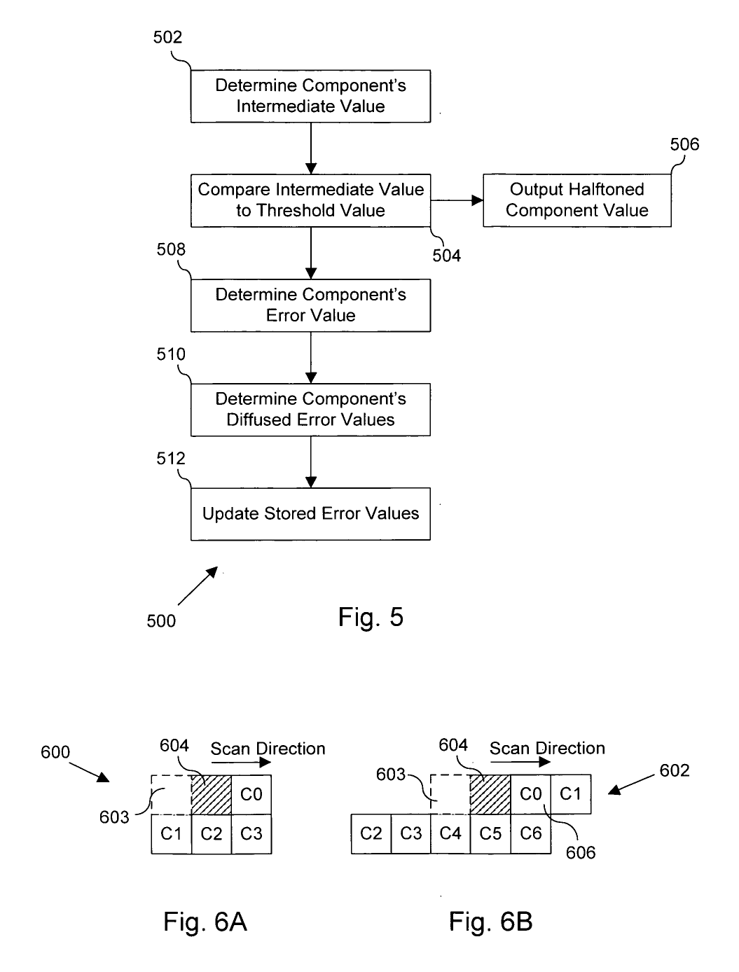

FIG. 4 is a simplified block diagram of a vector ED core 400, such as one of ED cores 304 of FIG. 3, for use in a parallel architecture for vector ED processing in accordance with an implementation of the invention. Core 400 includes thresholder 402, a sequential multiply engine 404, one or more ED filter lookup tables 406 and error buffer updater 408. Those skilled in the art will recognize that the components of core 400 may be implemented in any combination of hardware, firmware and/or software. Details of the components of core 400 and how they may function in implementations of the invention will be described below with respect to process 500 of FIG. 5.

Thresholder 402 may be any combination of hardware, firmware or software capable of comparing an intermediate pixel component value (inter) with the threshold value to determine an output pixel component value (out-pix). Sequential multiply engine 404 may, in accordance with the claimed invention, comprise any combination of hardware, firmware and/or software capable of sequentially determining a pixel component's diffused error values by multiplying that component's error value (err) by a sequence of ED coefficient values associated with certain of the pixel's neighboring pixels. Filter lookup tables 406 may comprise any mechanism of holding and/or storing and/or providing ED filter coefficient values in response to an index (Count) provided by engine 404. Updater 408 may comprise any combination of hardware, firmware and/or software capable of being updated and/or of updating output buffer 306 with output error data and/or values in response to diffused error values (update value) and/or count indices provided by engine 404.

FIG. 5 is a flow diagram illustrating a process 500 for providing vector ED processed halftone image data (e.g., halftone pixel component values) using a parallel architecture for vector color ED in accordance with an implementation of the claimed invention. While, for ease of explanation, process 500, and associated processes, may be described with regard to system 100 of FIG. 1 and components thereof shown in FIGS. 2-4 such as core 400 of FIG. 4, the claimed invention is not limited in this regard and other processes or schemes supported and/or performed by appropriate devices in accordance with the claimed invention are possible.

Process 500 may provide halftone image data using a variety of ED filter structures. For example, FIG. 6A illustrates a representative 4-tap ED filter 600 while FIG. 6B illustrates a representative 7-tap ED filter 602. As those skilled in the art will recognize, process 500 may be part of a raster scan image conversion process. Moreover, those skilled in the art will recognize that process 500 may be implemented in the context of either filter 600 and/or filter 602, or a variety of other ED filters (not shown), where process 500 diffuses errors to the pixel presently being processed, e.g., pixel 604, from pixels previously processed in the image row above pixel 604 (assuming that the row being processed is not the first row of the image) and diffuses pixel 604's error to neighboring pixels according to the filter's coefficients associated with those neighboring pixels (e.g., coefficient CO associated with pixel 606). A large variety of ED filter structures and/or coefficient values may be utilized, in accordance with the claimed invention, depending upon the type of image data being processed and/or the throughput (e.g., pages/minute) and/or the quality (i.e., accuracy) of halftone image processing desired.

To further facilitate understanding of implementations of the invention, description of process 500 and its implementation by core 400 will be made with reference to the following example pseudo-code for implementation of a 7-tap ED filter such as filter 602 of FIG. 6B where the maximum filter tap value is seven.

| //////////////////////////////////////////////////////////////// | | | |
|---|---|---|---|
| // INPUTs | : | uint8 inp_pix, int12/int8 inp_err | |
| // | | | |
| // OUTPUTs | : | uint1/uint2 out_pix, int12/int8 out_err | |
| // | | | |
| // Variables | : | int12 eb(5:0) | -> Error buffer |
| // | | int12 inter | -> Intermediate Value |
| // | | int12/uint8 thresh | -> Threshold Value |
| // | | uint8 C0..C6 | -> Coefficients |
| // | | int12 err | -> Error for the pixel |
| // | | | |

| | | |
|---|---|---|
| // Note | : | The result of the “/” operation |
| // | | is rounded DOWN to the nearest integer. |
| // | | (Implemented as a arithmetic right shift) |

| //////////////////////////////////////////////////////////////// | | |
|---|---|---|
| 1. for q = 1 to num_rows do | | |
| 2. Initialize eb(5:0) = {0, 0, 0, 0, 0, 0}; | | |
| 3. for p = 1 to row_width in do | | |
| 4. Inter = inp_pix + eb(0) + inp_err; | | |
| 5. out_pix = GET_PIXOUT(Inter, thresh); | | |
| 6. err | = GET_ERROR(Inter, out_pix); | |
| 7. eb(0) | = eb(1) | + (err * C0)/256; |
| 8. eb(1) | = 0 | + (err * C1)/256; |
| 9. if p > 3 | | |
| 10. out_err | = eb(2) | + (err * C2)/256; |
| 11. end if; | | |
| 12. eb(2) | = eb(3) | + (err * C3)/256; |
| 13. eb(3) | = eb(4) | + (err * C4)/256; |
| 14. eb(4) | = eb(5) | + (err * C5)/256; |
| 15. eb(5) | = 0 | + (err * C6)/256; |

16. end for;
17. out_err = eb(2);
18. out_err = eb(3);
19. out_err = eb(4);
20. end for;

Referring to the above pseudo-code and to FIGS. 4, 5 and 6B, process 500 may begin with the determination of an intermediate value (inter) for the pixel component being processed [act 502]. In one implementation, core 400 may determine the intermediate value by combining pixel 604's component value being processed (inp_pix) with the value of the error diffused from that color component of the most recently processed pixel 603 (eb(0)) along with the value of the input error value (inp_err) associated with and diffused to that pixel from previously processed pixels according to the ED filter's structure. In one implementation, core 400 may generate the intermediate component value from a numerical sum of inp_pix, inp_err and eb(0). Line 4 of the example pseudo-code illustrates an implementation of the intermediate value determination.

Process 500 may continue with a comparison of the intermediate value generated in act 502 with a halftone threshold value (thresh) [act 504]. In one implementation, thresholder 402 may undertake the comparison of act 504 using a threshold value provided to core 400 as configuration data. The result of comparing the intermediate pixel value with the threshold value may be output as a halftone output pixel component value (out_pix) [act 506]. One way to do this is if the component's intermediate value exceeds or equals the threshold value then thresholder 402 may generate a halftone output pixel component with a value of one; otherwise thresholder 402 may generate a halftone output pixel component with a value of zero. Line 5 of the example pseudo-code provides an example call to an output component generating function the details of which are not limiting with regard to the claimed invention.

Process 500 may continue with the determination of the component's error value (err) [act 508]. In one implementation, core 400 may combine the intermediate component value (inter) with a negation of the output component value (—(out_pix)) to generate the component's error value. For example, if the intermediate value exceeds threshold value such that the output component has a value of one then the component's error value will be proportional to the intermediate value minus the maximum input pixel value. For example, a value ranging from 0-255 may be halftoned to either 0 or 1 where an output component value of 1 corresponds to a input value of 255. Alternatively, if the threshold value exceeds the intermediate value such that the output component has a value of zero then the error value will be proportional to the intermediate value. Line 6 of the pseudo-code provides an example call to an error generating function the details of which are not limiting with regard to the claimed invention.

Process 500 may continue with a determination of the component's diffused error values (eb(0) and out_err) [act 510]. In one implementation, sequential multiply engine 404, in conjunction with filter lookup tables 406, may determine the component's diffused error values. A more detailed discussion of one implementation of act 510 will be provided below.

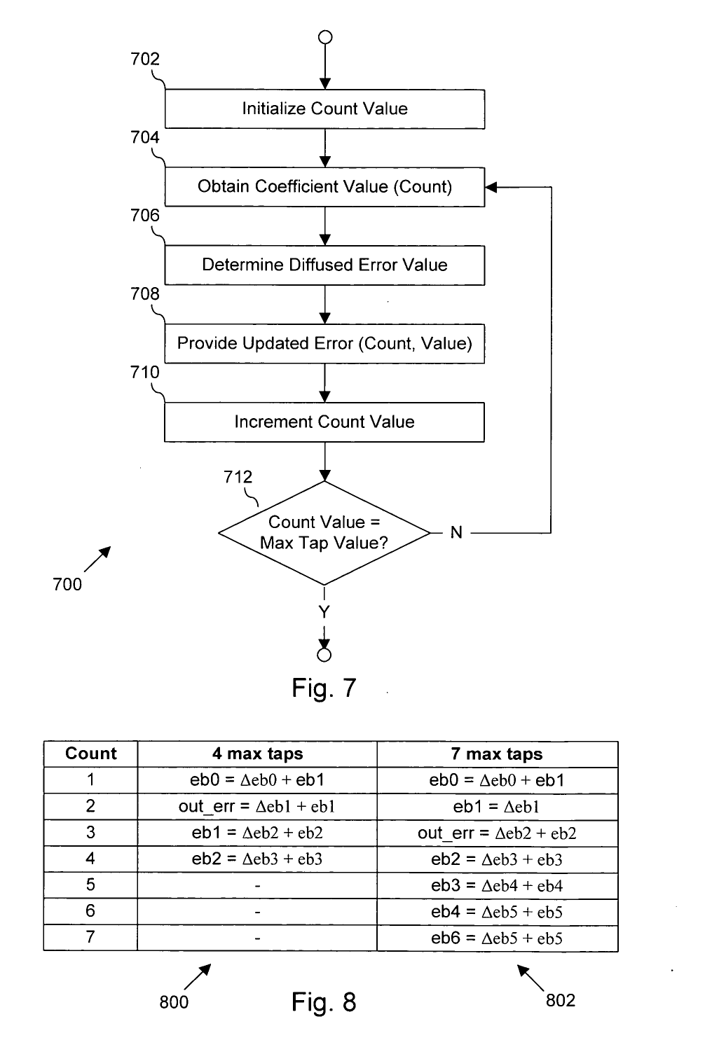

Process 500 may conclude with an update of stored error values [act 512] with the component's diffused error values (out_err and eb(0)) determined in act 510. One way to do this is for engine 404 to provide updater 408 with count and buffer update value pairs. Both updater 408 and buffer 308 may be updated with different ones of those values. In addition, updater 408 may also provide the diffused component error value associated with pixel 603 (eb(0)) and used to calculate pixel 604's intermediate component value in act 502. A more detailed discussion of acts 510 and 512 will be provided below with respect to FIGS. 7 and 8.

FIG. 7 is a flow diagram illustrating one implementation of a process 700 for determining a component's diffused error values in accordance with act 510 and for correspondingly updating error values in accordance with act 512. FIG. 8 illustrates example iterative schemes 800 and 802 for updating errors in accordance with implementations of the claimed invention for respective 4 max tap and 7 max tap filters such as filters 600 and 602 of FIGS. 6A/6B. Those skilled in the art will recognize that process 700 and schemes 800/802 may be undertaken, in accordance with the claimed invention, in a substantially parallel manner by different ones of cores 304 for each color component of an input pixel's data.

Process 700 may begin with an initialization of a filter tap value and/or a count value (count) [act 702]. In one implementation, sequential multiply engine 404, in conjunction with filter lookup tables 406, may determine a component's diffused error values in accordance with act 510 and may do so by using the count value as a lookup index value for accessing ED coefficient values stored and/or held in lookup tables 406. To do so, engine 404 may first initialize the count value index when performing act 510 for each pixel component being processed in accordance with processes 500 and 700.

Process 700 may continue with a coefficient value being obtained [act 704]. In one implementation, engine 404 may obtain a coefficient value from lookup tables 406 using the count value as an index to that coefficient value. In one implementation, after the count value is initialized in act 702, engine 404 my obtain a coefficient value stored in lookup tables 406 and associated, according to ED filter 602's structure, with a neighboring pixel by presenting a count and/or filter tap value to one of lookup tables 406. As those of skill in the art will recognize, the count and/or filter tap value may range from one to the maximum number of filter taps in the filter structure being applied. For example, filter 602 of FIG. 6B has seven filter taps.

In the example of filter 602 of FIG. 6B, and as illustrated by line 7 of the example pseudo-code, in response to a count value of zero the C0 coefficient associated with pixel 606 immediately adjacent the pixel being processed may be provided to engine 404. However, as noted above the invention is not limited in this regard and ED filter structures other than those shown in FIGS. 6A/6B and other associated pseudo-codes may be used without departing from the scope and spirit of the invention.

Once a coefficient value has been obtained in act 704, process 700 may continue with a determination of the corresponding diffused error value [act 706]. In one implementation, engine 404 may determine the diffused error value by multiplying the coefficient obtained in act 704 by the error value (err) determined in act 508.

Process 700 may continue with the updating of the error value [act 708]. For example, once the diffused error value for a corresponding count value has been determined in act 706, engine 404 may provide updater 408 with a count and update value pair (out_err) for updating of either updater 408 or error buffer 308. In accordance with the claimed invention, whether updater 408 or error buffer 308 is updated in act 708 may depend on the filter structure used. For example, in error diffusion processing using filter 600 and following scheme 802, error buffer 308 may be updated for count 1 while updater 408 is updated for counts 2 and 3. Alternatively, if, for example, error diffusion processing is undertaken using filter 602 and following scheme 802, error buffer 308 may be updated for count 2 (e.g., line 10 of the above pseudo-code) while updater 408 is updated for all other counts 1 and 3-6 (e.g., pseudo-code lines 7-8 and 12-15).

In accordance with the claimed invention, core 400 may undertake acts 702-708 for a particular color pixel component value (e.g., the CMYK cyan component value) while others of cores 304 undertake acts 702-708 in a substantially simultaneous manner for other color pixel component values (e.g., one each of cores 304 for each of the remaining CMYK magenta, yellow and black color components of the pixel being processed). Thus, cores 304 may provide output buffer 306 with respective component's diffused error values in a packed data format and subsequently update error buffer 308 with those packed error values.

Process 700 may continue with the incrementing of the count value [act 710] and a subsequent comparison of the incremented count value with a max tap value [act 712]. In one implementation, engine 404 may undertake acts 710 and 712. In one implementation, engine 404 may increment the count value from zero to one and may compare that incremented count value to the max tap value associated with a specific ED filter stored and/or held in lookup tables 406. For example, an ED filter such as filter 602 will have a max tap value of seven and hence implementation of act 712 may yield a negative result whenever the count value is less than seven.

If the result of the comparison of act 712 is a negative value then acts 704-710 may repeat as shown in FIG. 7. Each subsequent iteration of acts 704-710 may involve the determination of an associated diffused error value and the updating of either updater 408 or error buffer 308 with the corresponding error value. More particularly, depending upon the ED filter type and size, once all iterations of acts 704-710 has occurred for each pixel processed, error buffer 308 may be updated once (e.g., with a diffused error value corresponding to out_err) while updater 408 may be updated with the remaining diffused error values. For example, referring to 7-tap ED filter 602 whose circular error buffer operations may be represented by scheme 804 and lines 8-15 of the example pseudo-code, engine 404 may update updater 408 with diffused error values for counts 1-2 and 4-7 while updating buffer 306 (via updater 408) with the diffused error value for count value three. Clearly, many different filter types and sizes and associated circular error buffer operations may be implemented consistent with the claimed invention.

Once the comparison of act 712 results in a positive determination (i.e., once the incremented count value equals the max tap value) for the ED filter being implemented) then processes 500 and 700 may complete.

The acts shown in FIGS. 5 and 7 need not be implemented in the order shown; nor do all of the acts necessarily need to be performed. For example, the coefficients used for determining the diffused error values in act 706 may be hard coded within engine 404 obviating the need to obtain those coefficients (e.g., from lookup tables 406) in act 704. In other words, a multiply engine scheme of a parallel architecture for vector color error diffusion in accordance with the invention can be made rigid in the sense that there may be as many multipliers as there are taps with each multiplier using a corresponding coefficient hard coded as a constant value. Also, those acts that are not dependent on other acts may be performed in parallel with the other acts. Further, at least some of the acts in this figure may be implemented as instructions, or groups of instructions, implemented in a machine-readable medium.

The foregoing description of one or more implementations consistent with the principles of the invention provides illustration and description, but is not intended to be exhaustive or to limit the scope of the invention to the precise form disclosed. Modifications and variations are possible in light of the above teachings or may be acquired from practice of various implementations of the invention. For example, the threshold value used may be a configurable value as opposed to a constant value. Moreover, the coefficients used by sequential multiply engine 404 may be component dependent and hence may be obtained from one of a plurality of component-specific lookup tables (i.e., one lookup table for each component). Clearly, many other implementations may be employed to provide a parallel architecture for vector color error diffusion consistent with the claimed invention.

No element, act, or instruction used in the description of the present application should be construed as critical or essential to the invention unless explicitly described as such. Also, as used herein, the article “a” is intended to include one or more items. In addition, some terms used to describe implementations of the invention, such as “data” and “value,” may be used interchangeably in some circumstances. For example, those skilled in the art will recognize that the terms “error data” and “error value” may be used interchangeably without departing from the scope and spirit of the invention. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method comprising:
determining a halftone error value for each color component of an input pixel; and
determining, in a substantially parallel manner, color component diffused error values for neighboring pixels by sequentially multiplying the halftone error value by corresponding coefficients of an error diffusion filter.

2. The method of claim 1, further comprising:
buffering at least one of the color component diffused error diffusion values in a circular error buffer.

3. The method of claim 1, further comprising:
obtaining the coefficients of the error diffusion filter by indexing one or more lookup tables.

4. The method of claim 3, wherein the one or more lookup tables comprise separate lookup tables for each color component.

5. The method of claim 4, wherein the color components comprise cyan, magenta, yellow and black.

6. The method of claim 1, further comprising:
selecting the error diffusion filter from a plurality of error diffusion filters.

7. The method of claim 6, wherein each of the plurality of error diffusion filters comprises a lookup table of indexed coefficients.

8. The method of claim 7, wherein sequentially multiplying comprises indexing a lookup table in response to a state of a sequential multiplier.

9. A system comprising:
processing logic at least capable of:
thresholding intermediate values of color components of input image pixel data to generate output color component values and associated component error values;
sequentially multiplying, in a substantially parallel manner, the component error values by corresponding error diffusion coefficients to generate component diffused error values; and
temporarily storing at least one of the component diffused error values in a circular error buffer; and
an image output device responsive to the processing logic.

10. The system of claim 9, wherein the image output device comprises a color printer, memory and/or another image processor.

11. The system of claim 9, wherein the processing logic also includes a plurality of lookup tables to hold the error diffusion coefficients.

12. The system of claim 11, wherein the plurality of lookup tables comprises one lookup table for each color component.

13. The system of claim 12, wherein the color components comprise cyan, magenta, yellow and black

14. A device comprising:
a plurality of error diffusion cores to diffuse halftone processing errors for color components of one or more input pixels by having each core of the plurality of cores substantially in parallel:
determine a component error value for a color component by comparing an intermediate component value to a threshold value; and
sequentially multiply the component error value by a plurality of error diffusion coefficients to generate diffused error values for that component; and
a circular error buffer responsive to the plurality of cores, the buffer to temporarily store at least one of the diffused error values for the color components of the one or more input pixels.

15. The device of claim 14, further comprising:
one or more lookup tables to store the plurality of error diffusion coefficients.

16. The device of claim 15, wherein the one or more lookup tables comprise one lookup table for each color component.

17. The device of claim 16, wherein the color components comprise cyan, magenta, yellow and black.

18. The device of claim 17, wherein the plurality of diffusion cores comprises at least four diffusion cores.

19. The device of claim 15, wherein the diffusion coefficients in each lookup table are indexed by a filter tap value.

20. The device of claim 19, wherein sequentially multiplying comprises:
multiplying the component error value by different ones of the error diffusion coefficients of at least one of the lookup tables in response to sequentially incrementing filter tap values.

21. An article comprising a machine-accessible medium having stored thereon instructions that, when executed by a machine, cause the machine to:
determine a halftone error value for a each color component of an input pixel; and
determine, in a substantially parallel manner, color component diffused error values for neighboring pixels by sequentially multiplying the halftone error value by corresponding coefficients of an error diffusion filter.

22. The article of claim 21, wherein the instructions, when executed by a machine, further cause the machine to:
buffer at least one of the color component diffused error diffusion values in a circular error buffer.

23. The article of claim 21, wherein the instructions, when executed by a machine, further cause the machine to:
obtain the coefficients of the error diffusion filter by indexing one or more lookup tables.

24. The article of claim 23, wherein the one or more lookup tables comprise separate lookup tables for each color component.

25. The article of claim 21, wherein the instructions, when executed by a machine, further cause the machine to:
select the error diffusion filter from a plurality of error diffusion filters.

26. The article of claim 25, wherein each of the plurality of error diffusion filters comprises a lookup table of indexed coefficients.

27. The article of claim 25, wherein the instructions that, when executed by a machine, cause the machine to sequentially multiply the halftone error value by corresponding coefficients of an error diffusion filter, cause the machine to:
index a lookup table in response to a state of a sequential multiplier.
